(19) United States
(12) Patent Application Publication
(10) Pub. No.: US 2025/0268447 A1
(43) Pub. Date: Aug. 28, 2025

(54) VESSEL RINSING APPARATUS

(71) Applicant: Kraus USA Plumbing LLC, Port Washington, NY (US)

(72) Inventors: Serhiy Torak, Noblesville, IN (US); Todd Alexander, Hollis, NH (US)

(21) Appl. No.: 19/034,007

(22) Filed: Jan. 22, 2025

Related U.S. Application Data
(60) Provisional application No. 63/557,460, filed on Feb. 23, 2024.

(51) Int. Cl. A47L 15/00; A47L 15/42

(52) U.S. Cl. CPC A47L 15/0065; A47L 15/421; A47L 15/4217; A47L 15/4223

(57) ABSTRACT

A vessel rinsing apparatus including a drain bowl. a fluid discharge control including trigger and a sprayface having an outlet. A valve is operably coupled to the fluid discharge control and configured to control water flow through the outlet, and a lock to prevent movement of the trigger to a lowered position.

### CROSS-REFERENCE TO RELATED APPLICATION

The present application claims priority to U.S. Provisional Patent Application Ser. No. 63/557,460, filed Feb. 23, 2024, the disclosure of which is expressly incorporated herein by reference.

### BACKGROUND AND SUMMARY OF THE DISCLOSURE

The present invention relates generally to a fluid dispensing system and, more particularly, to a vessel rinsing apparatus for use with containers, such as fluid vessels or receptacles, including drinkware (e.g., cups, bottles and/or glasses).

Glass rinsers are known in the art to provide for the cleaning of various containers. However, there is a need for a vessel rinser that may be mounted to a sink deck for draining into a sink basin and including a lockout mechanism to prevent inadvertent actuation thereof.

According to an illustrative embodiment of the present disclosure, a vessel rinsing apparatus includes a hollow, cylindrical mounting shank extending along a longitudinal axis, the mounting shank defining a first fluid passageway. A valve includes a valve seat supported by the mounting shank, a valve stem movable along the longitudinal axis, and a valve seal supported by the valve stem. The valve stem is movable between a closed position and an open position. The valve seal is bias against the valve seat in the closed position. A fluid discharge control includes a central body extending along the longitudinal axis and at least partially disposed within the mounting shank, wherein the central body includes a second fluid passageway. A sprayface is supported by a first end of the central body and includes at least one outlet in fluid communication with the second fluid passageway. A trigger is operably coupled to the central body, wherein the trigger is movable for axial movement along the longitudinal axis between a raised position and a lowered position. The trigger is movable for rotational movement about the longitudinal axis between a first rotation position and a second rotational position. The trigger is biased towards the raised position. Moving the trigger to the lowered position is configured to move the valve seal away from the valve seat causing the valve to be in the open position. A lock is configured to prevent movement of the trigger to the lowered position when the trigger is in the first rotational position. A drain bowl is operably coupled to the mounting shank, the drain bowl being defined by a base and an upwardly extending wall.

According to another illustrative embodiment of the present disclosure, a drinkware rinsing apparatus includes a drain bowl defined by a base and an upwardly extending wall. A valve includes a valve seat supported by the mounting shank, a valve stem movable along the longitudinal axis, and a valve seal supported by the valve stem. The valve stem is movable between a closed position and an opened position. The valve seal is biased against the valve seat in the closed position. A fluid discharge control includes a central body extending along the longitudinal axis and at least partially disposed within the mounting shank, wherein the central body includes an outlet fluid passageway. A sprayface is supported by a first end of the central body and includes at least one outlet in fluid communication with the fluid passageway. The sprayface is located substantially within the drain bowl. A trigger is operably coupled to the central body, wherein the trigger is movable for axial movement along the longitudinal axis between a raised position and a lowered position. The trigger is biased towards the raised position. The trigger is movable for rotational movement about the longitudinal axis between a first rotational position and a second rotation position. The trigger is biased toward the first rotational position. Moving the trigger to the lowered position is configured to move the valve seal away from the valve seat causing the valve to be in the open position. A lock is configured to prevent movement of the trigger to the lowered position when the trigger is in the first rotational position.

According to a further illustrative embodiment of the present disclosure, a vessel rinsing apparatus includes a hollow, cylindrical mounting shank extending along the longitudinal axis, the mounting shank defining the first fluid passageway. A valve includes a fixed valve member supported within the mounting shank and defining a valve seat, a valve stem movable along the longitudinal axis, and a valve seal supported by the valve stem. The valve stem is movable between a closed position and an open position. The valve seal is bias against the valve seat in the closed position. A fluid discharge control includes a central body extending along the longitudinal axis and at least partially disposed within the mounting shank, wherein the central body includes a second fluid passageway. A sprayface is supported by a first end of the central body and includes at least one outlet in fluid communication with the second fluid passageway. A trigger is operably coupled to the central body. The trigger is movable for axial movement along the longitudinal axis between a raised position and lowered position. The trigger is movable for rotational movement about the longitudinal axis between a first rotational position and a second rotational position. The trigger is bias towards the raised position. Moving the trigger to the lowered position is configured to move the valve seal away from the valve seat causing the valve to be in the open position. The lock is configured to prevent movement of the trigger to the lowered position when the trigger is in the first rotational position. A rotatable drive is operably coupled to the central body. An engagement surface is supported by the rotatable drive and is configured to move the valve stem toward the open position when the trigger is in the lowered position. A drain bowl is operably coupled to the mounting shank, the drain bowl being defined by a base and an upwardly extending wall. A drain channel extends through the upwardly extending wall of the drain bowl. In an installed condition of the rinsing apparatus, the drain bowl is positioned above the mounting deck, at least a portion of the drain channel is positioned above the sink basin, and the drain channel is configured to receive fluid from the drain bowl and discharge the fluid above and into the sink basin.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

A detailed description of the drawings particularly refers to the accompanying figures, in which:

FIG. 1 is a perspective view of an illustrative vessel rinsing apparatus mounted to a sink deck and fluidly coupled to a faucet;

FIG. 2 is a perspective view of the illustrative vessel rinsing apparatus of FIG. 1;

FIG. 3 is a perspective view of the vessel rinsing apparatus of FIG. 2, showing the quick connect coupler uncoupled from the mounting shank;

FIG. 4 is an exploded perspective view of the vessel rinsing apparatus of FIG. 1;

FIG. 5 is a cross-sectional view taken along line 5-5 of FIG. 2, showing the quick connect coupler of the vessel rinsing apparatus;

FIG. 6A is a cross-sectional view taken along line 6-6 of FIG. 3, showing a glass positioned above the trigger of the vessel rinsing apparatus;

FIG. 6B is a partial cross-sectional view of the vessel rinsing apparatus of FIG. 6A, showing the valve in a closed position;

FIG. 6C is a top plan view of the vessel rinsing apparatus of FIG. 6A;

FIG. 7A is a cross-sectional view taken along line 6-6 of FIG. 3, showing a glass depressing the trigger of the vessel rinsing apparatus;

FIG. 7B is a partial cross-sectional view of the vessel rinsing apparatus of FIG. 7A, showing the valve in an open position;

FIG. 7C is a top plan view of the vessel rinsing apparatus of FIG. 7A;

FIG. 8 is a partial perspective view, in cross-section, showing the trigger of the vessel rinsing apparatus of FIG. 1;

FIG. 9 is a perspective view of the trigger of FIG. 8;

FIG. 10 is a cross-sectional view taken along line 10-10 of FIG. 9;

FIG. 11A is a cross-sectional view showing a first position of the trigger of the vessel rinsing apparatus of FIG. 2;

FIG. 11B is a cross-sectional view showing a downward axial force applied to the trigger of FIG. 11A;

FIG. 11C is a cross-sectional view showing a second position of the trigger of FIG. 11A as a rotational force and a downward axial force is applied to the trigger;

FIG. 12 is a perspective view of the mounting shank of the vessel rinsing apparatus of FIG. 2;

FIG. 13 is a perspective view of the rotatable drive of the trigger of the vessel rinsing apparatus of FIG. 2;

FIG. 14 is a perspective view of the fixed valve member of the vessel rinsing apparatus of FIG. 2;

FIG. 15 is a top plan view of an illustrative sink including a vessel rinsing apparatus of the present disclosure; and

FIG. 16 is a partial perspective view of the illustrative sink of FIG. 15.

### DETAILED DESCRIPTION OF THE DRAWINGS

For the purposes of promoting and understanding the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

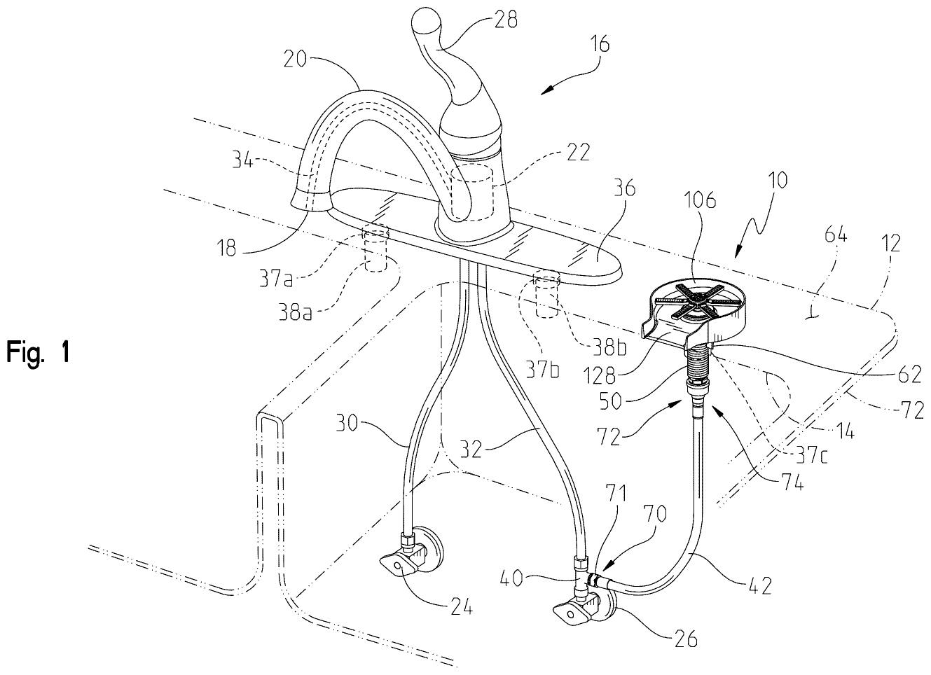

With reference initially to FIG. 1 of the drawings, an illustrative vessel rinsing apparatus or glass rinser 10 is shown supported by a conventional mounting deck, such as a sink deck 12 supporting a sink basin 14. A faucet 16 may be supported by the sink deck 12 for discharging water from a water outlet 18 into the sink basin 14. The faucet 16 may be of conventional design, including a delivery spout 20 defining the water outlet 18, and a manual mixing valve 22 for controlling water flow from a hot water supply (e.g., a hot water stop) 24 and a cold water supply (e.g., a cold water stop) 26 to the water outlet 18.

The mixing valve 22 may be of conventional design including a valve handle 28 to control the flow rate and the temperature of water delivered to the water outlet 18. A hot water supply tube 30 may fluidly couple the hot water supply 24 to a first inlet of the mixing valve 22, and a cold water supply tube 32 may fluidly couple the cold water supply 26 to a second inlet of the mixing valve 22. A mixed water outlet passageway 34, illustratively a tube received within the spout 20, may fluidly couple an outlet of the mixing valve 22 to the outlet 18.

An escutcheon 36 may be positioned intermediate the sink deck 12 and the delivery spout 20. A plurality of mounting apertures 37 may extend within the sink deck 12, wherein at least some of the apertures 37a, 37b may receive mounting shanks 38a, 38b used to couple the faucet 16 to the sink deck 12. In the illustrative embodiment, the glass rinsing apparatus 10 is fixed to the mounting aperture 37c that would conventionally support a kitchen side sprayer (not shown) adjacent the sink basin 14. Such positioning facilitates draining of the vessel rinsing apparatus 10 into the sink basin 14.

A fluid coupler 40, illustratively a T-fitting, provides fluid communication between the cold water stop 26 and the faucet 16, and between the cold water stop 26 and the vessel rinsing apparatus 10. More particularly, the cold water supply tube 32 fluidly couples the T-fitting 40 and the mixing valve 22 of the faucet 16, while a fluid dispensing apparatus or vessel rinser supply tube 42 fluidly couples the T-fitting 40 and the vessel rinsing apparatus 10. In other illustrative embodiments, a diverter valve (not shown) may be operably coupled between the vessel rinsing apparatus 10 and the faucet 16 to toggle water therebetween. Such a diverter valve arrangement is shown in U.S. Pat. No. 10,914,056 to Cipriani et al., the disclosure of which is expressly incorporated herein by reference.

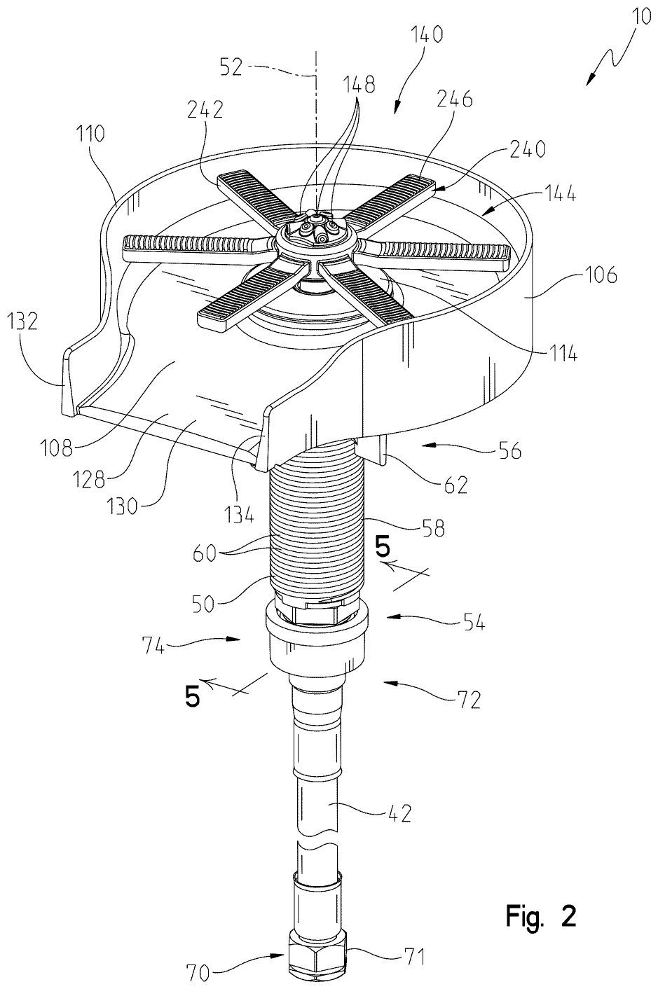

With reference now to FIGS. 2-5, the illustrative vessel rinsing apparatus or glass rinser 10 includes a mounting shank 50 configured to extend through the sink deck 12. The mounting shank 50 is hollow and extends vertically along a longitudinal axis 52 between a lower end 54 and an upper end 56. More particularly, the illustrative mounting shank 50 includes a cylindrical side wall 58 having a plurality of lower external threads 60 to receive a mounting nut 62. Cooperation between the mounting shank 50 and the mounting nut 62 couple the vessel rinsing apparatus 10 to an upper surface 64 of the sink deck 12 (FIG. 1).

With reference to FIGS. 1-6B, the mounting shank 50 defines a first fluid passageway 66 extending upwardly from the lower end 54. As noted above, the vessel rinser supply tube 42 fluidly couples the cold water supply 26 to the fluid dispensing apparatus 10. More particularly, a first end 70 of the supply tube 42 is fluidly coupled to the T-fitting 40 via a conventional nut coupler 71, and a second end 72 of the supply tube 42 is fluidly coupled to the lower end 54 of the mounting shank 50 via a quick-connect fitting 74. While an illustrative quick-connect fitting 74 is further detailed herein, it should be appreciated that other fluid couplings may be substituted therefor.

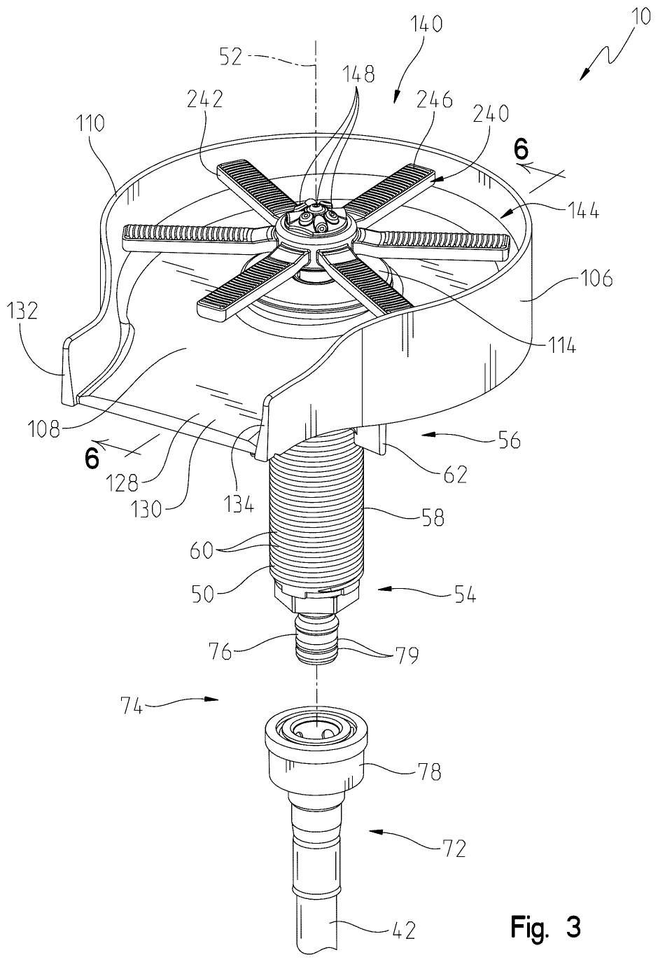

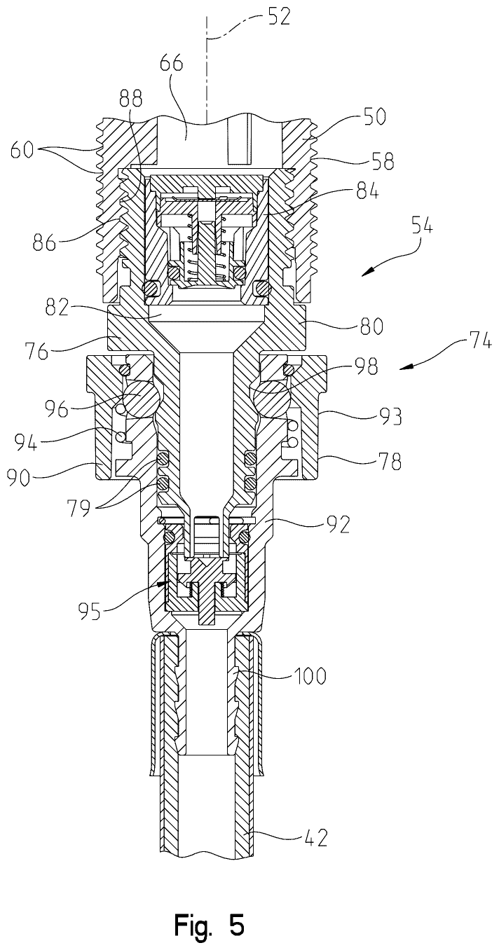

With further reference to FIGS. 3 and 5, the illustrative quick-connect fitting 74 includes a male portion or adapter 76 received within a female portion or receiver 78. Conventional o-rings 79 may be supported on the adapter 76 for sealing with the receiver 78. The male portion 76 includes an outer housing 80 defining an internal passageway 82 and receiving a check valve 84. The housing 80 includes external threads 86 cooperating with internal threads 88 of the mounting shank 50.

The receiver 78 of the quick-connect fitting 74 includes a receiver housing 90 receiving an inner core 92. An outer surface 93 of the receiver housing 90 may include gripping elements (e.g., texture, knurling, annular rings, etc.) to facilitate manipulation by a user. A spring 94 is positioned between the receiver housing 90 and the inner core 92. A valve 95 is supported by the inner core 92 and is configured to be opened when engaged by the outer housing 80 of the male portion 76. Retention balls 96 are supported by the inner core 92 and are configured to be received within an annular slot 98 of the male portion 76. A barbed fitting 100 on the receiver housing 90 retains the second end 72 of the supply tube 42 to the receiver 78.

With further references ro FIGS. 2-4, a drain bowl 106 is illustratively coupled to the upper end 56 of the mounting shank 50. The drain bowl 106 includes a lower wall or base 108 and an upwardly extending wall 110. Illustratively, the drain bowl 106 is contoured for the collection and disposal of debris and wastewater. The upper end 56 of the mounting shank 50 extends through an opening 112 of the base 108. A coupling nut 114 includes internal threads 116 that couple with upper external threads 118 of the mounting shank 50, and an upper flange 120 defining an opening 122. An o-ring 124 is supported by an upper flange 126 of the mounting shank 50 and received within the opening 112 of the base 108 to seal the mounting shank 50 with the drain bowl 106.

A drain channel 128 is in fluid communication with the drain bowl 106. The illustrative drain channel 128 may extend through the upwardly extending wall 110. Alternatively, the drain channel 128 may be defined independent from the upwardly extending wall 110. As shown in FIG. 1, the drain channel 128 is configured to provide fluid communication between the drain bowl 106 and the sink basin 14 supported by the sink deck 12. The drain channel 128 illustratively includes a channel lower wall or base 130 and opposing side walls 132 and 134. In an installed condition of the vessel rinsing apparatus 10, the drain bowl 106 is positioned above the mounting deck 12, at least a portion of the drain channel 128 is positioned above the sink basin 14, and the drain channel 128 is configured to receive fluid from the drain bowl 106 and discharge the fluid above and into the sink basin 14. The base 108 of the drain bowl 106 may be inclined downwardly toward the drain channel 128. Likewise, the base 130 of the drain channel 128 may be inclined downwardly toward the sink basin 14.

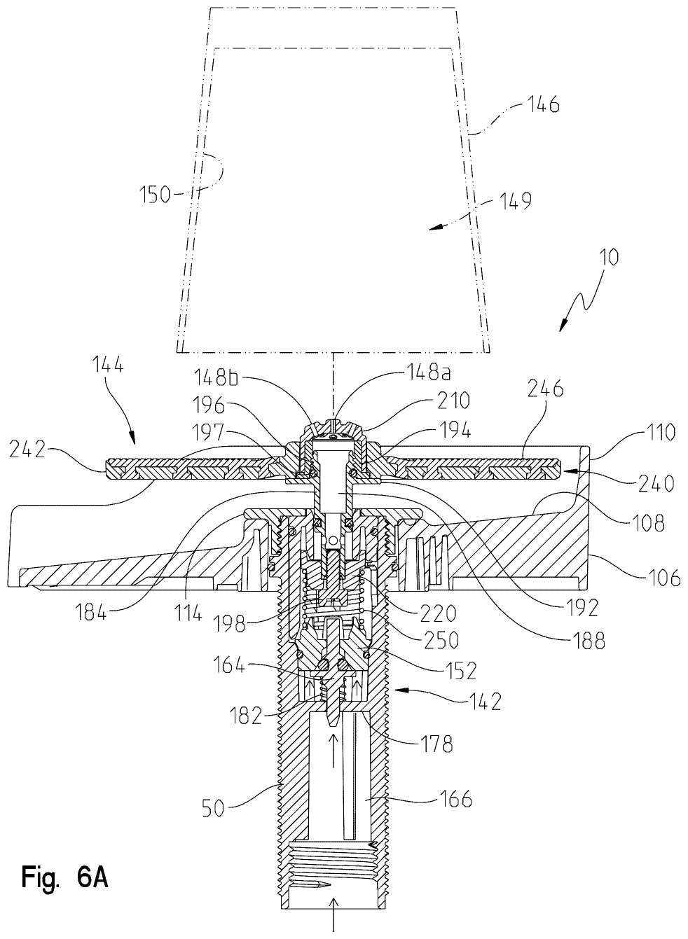

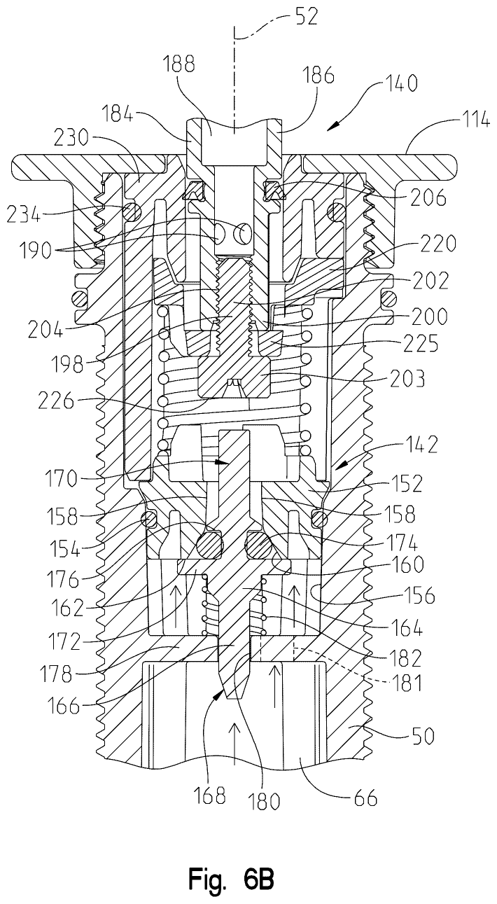

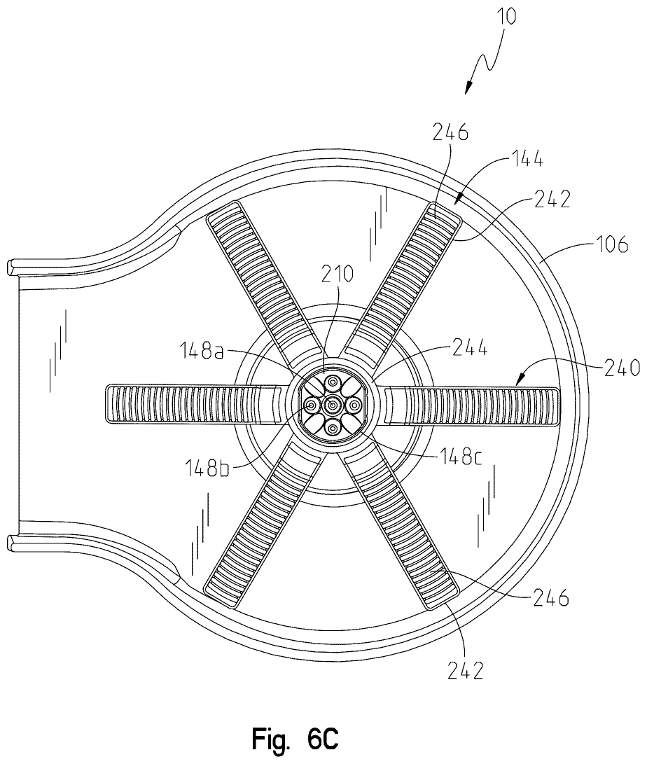

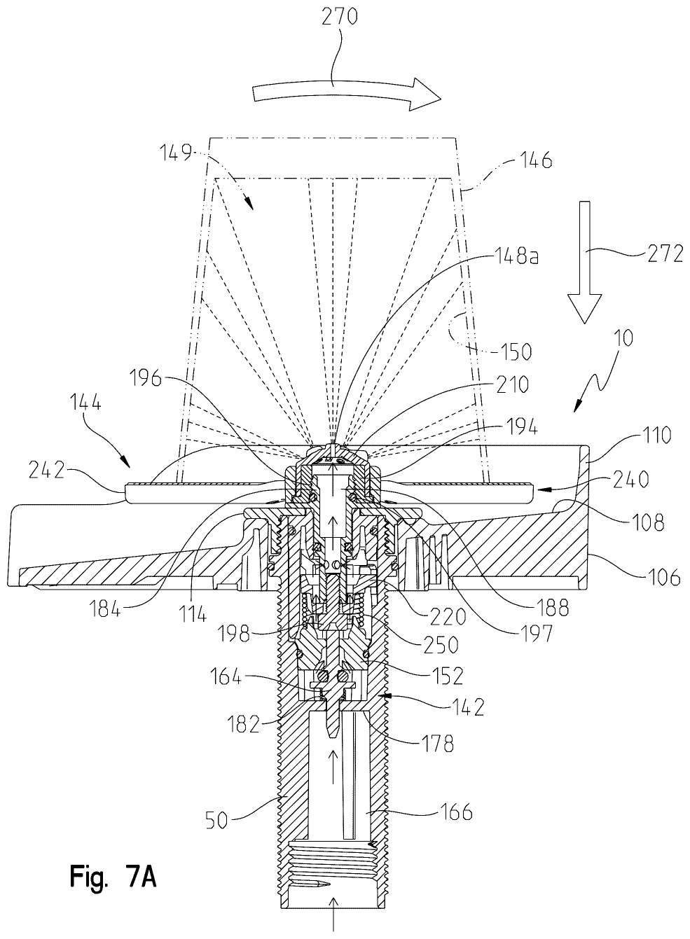

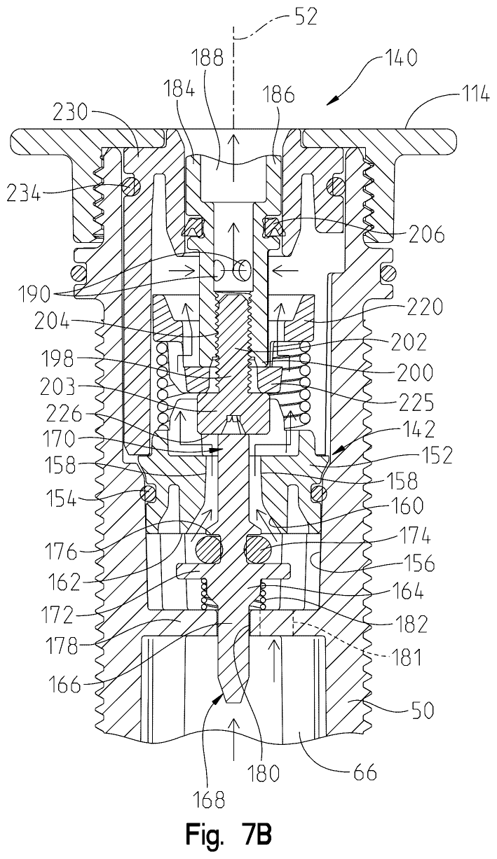

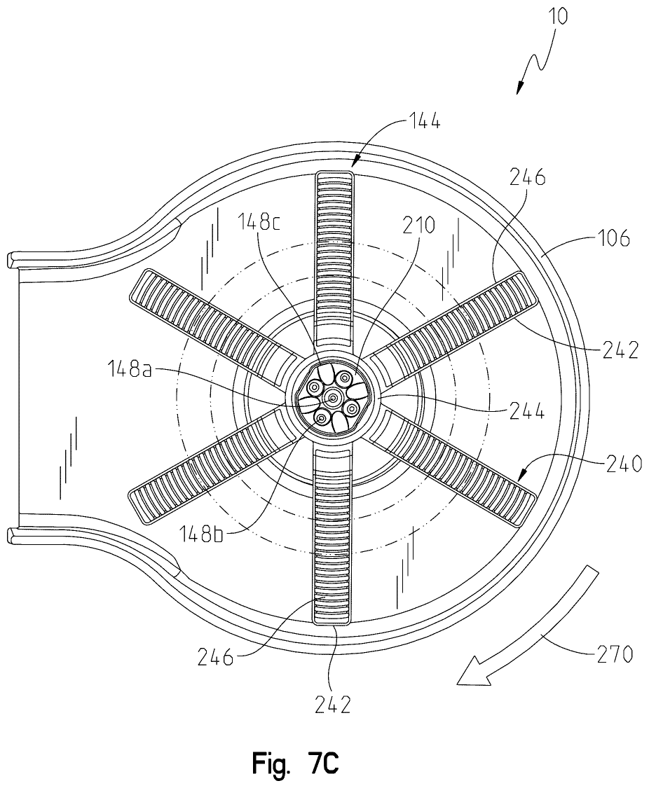

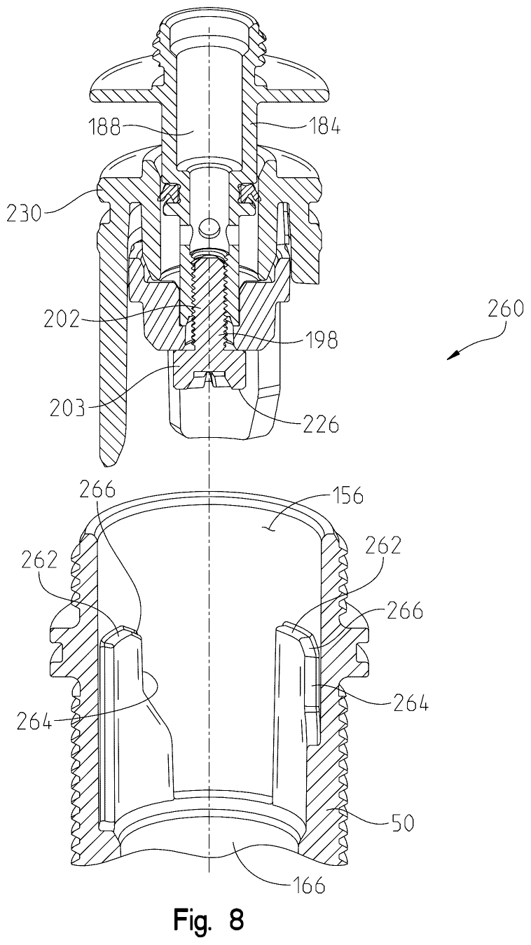

A fluid discharge control 140 is operably coupled to the drain bowl 106 and to a valve 142. As further detailed herein, the fluid discharge control 140 includes a trigger 144 configured to be engaged by a vessel 146 (e.g., a cup, glass, bottle or other container) for activating water flow through a plurality of outlets 148 and into an interior 149 of the vessel 146 to clean an internal surface 150 (FIGS. 6A and 7A).

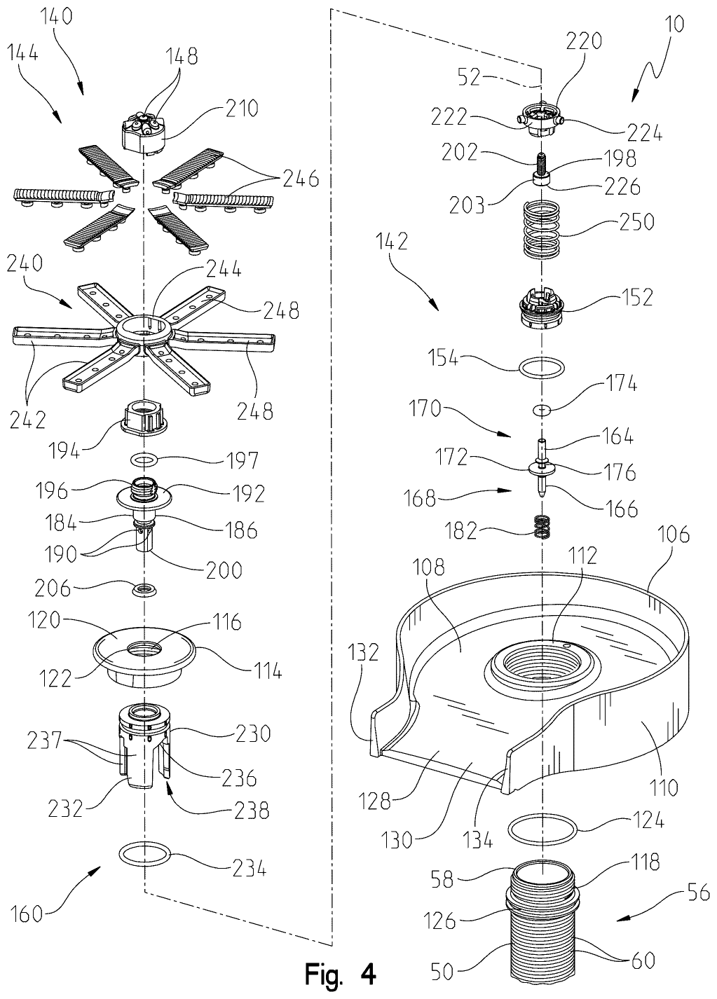

With reference to FIGS. 4, 6B and 7B, the illustrative valve 142 includes a fixed valve member 152, illustratively a diverter body, received within the mounting shank 50. An o-ring 154 is supported by the diverter body 152 and provides a seal with an inner surface 156 of the mounting shank 50. A center opening 158 extends through the diverter body 152. A valve seat 160 is supported by a lower surface 162 of the diverter body 152. A valve stem 164 is slidably received within the opening 158 of the diverter body 152.

More particularly, the valve stem 164 includes a shaft or pin 166 extending along the longitudinal axis 52 between a lower end 168 and an upper end 170. A retaining flange 172 is positioned intermediate the lower end 168 of the valve pin 166 and the upper end 170. A valve seal 174, illustratively an o-ring, is received within an annular groove 176 adjacent to the retaining flange 172. The mounting shank 50 includes an inwardly extending support wall 178 including a center opening 180 intermediate water flow openings 181 (FIGS. 6B, 7B and 12). The lower end 168 of the valve pin 166 of the valve stem 164 is slidably received within the center opening 180 of the support wall 178. The upper end 170 of the valve pin 166 of the valve stem 164 is slidably received within the center opening 158 of the diverter body 152.

The valve stem 164 is movable along the longitudinal axis 52 between a closed position and an open position. In the closed position, the valve seal 174 engages the valve seat 160 (FIG. 6A). In the open position, the valve seal 174 is spaced apart from the valve seat 160 (FIG. 7A). A spring 182 biases the valve stem 164 upwardly toward the closed position as shown in FIGS. 6A and 6B.

The fluid discharge control 140 is operably coupled to the valve 142. The fluid discharge control 140 illustratively includes a central body 184 including a cylindrical side wall 186 defining a second fluid passageway 188. A plurality of radial openings 190 are received within the side wall 186 and are in fluid communication with the second fluid passageway 188. The second fluid passageway 188 is in selective fluid communication with the first fluid passageway 66 of the mounting shank 50 via operation of the valve 142 between the closed position (FIGS. 6A and 6B) and the open position (FIGS. 7A and 7B).

The central body 184 extends along the longitudinal axis 52 and is at least partially disposed within the mounting shank 50. A mounting flange 192 is supported by the central body 184. A faceplate 194 is threadably coupled to an upper end 196 of the central body 184. An o-ring 197 is illustratively supported on the central body 184 adjacent the flange 192 and provides a seal between the central body 184 and the faceplate 194. An engagement member 198 is coupled to a lower end 200 of the central body 184. More particularly, the engagement member 198 illustratively includes a fastener having an externally threaded shaft 202 and a head 203. The threaded shaft 202 illustratively engages with internal threads 204 of the central body 184. A gasket 206, illustratively a lip seal, is supported by the upper end 196 of the central body 184.

A sprayface 210 is illustratively supported by the upper end 196 of the central body 184 and includes a plurality of outlets or nozzles 148 in fluid communication with the second fluid passageway 188. Illustratively, the nozzles 148 include a center nozzle 148a coaxially aligned with the center axis 52, a second or intermediate set of nozzles 148b positioned radially outwardly from the center nozzle 148a, and a third or outer set of nozzles 148c positioned radially outwardly from the intermediate set of nozzles 148b.

The illustrative sprayface 210 receives and is coupled to the faceplate 194. The nozzles 148 are illustratively oriented in different angular orientations from the longitudinal axis 52 to direct discharged water to different internal surfaces 150 of the vessel 146 (FIG. 7A).

More particularly, the illustrative sprayface 210 includes a single center nozzle 148a, four circumferentially spaced nozzles 148b, and four circumferentially spaced nozzles 148c. The nozzle 148a is configured to direct water generally upwardly along the center axis 52 (90 degrees from a plane defined by the trigger 144), the nozzles 148b are configured to direct water substantially 35 degrees from the center axis 52 (55 degrees from the plane defined by the trigger 144), and the nozzles 148c are configured to direct water substantially 70 degrees from the center axis 52 (20 degrees from the plane defined by the trigger 144). The orientation and positioning of the nozzles 148 are configured to effectively clean a variety of vessels and prevent splashing.

With reference to FIGS. 6B, 7B, 11A-11C and 13, the illustrative fluid discharge control 140 further includes a seal setter or rotatable drive 220 operably coupled to the central body 184. The rotatable drive 220 includes a body 222 having an upper cylindrical wall 222 supporting a plurality of radially outwardly extending pins 224. A lower flange or lip 225 of the body 222 is secured between the lower end 200 of the central body 184 and the head 203 of the engagement member 198. An engagement surface 226 is supported by the rotatable drive 220 and is configured to move the valve stem 164 toward the open position when the trigger 144 is in the lowered position. Illustratively, the engagement surface 226 is defined by the head 203 of the engagement member 198.

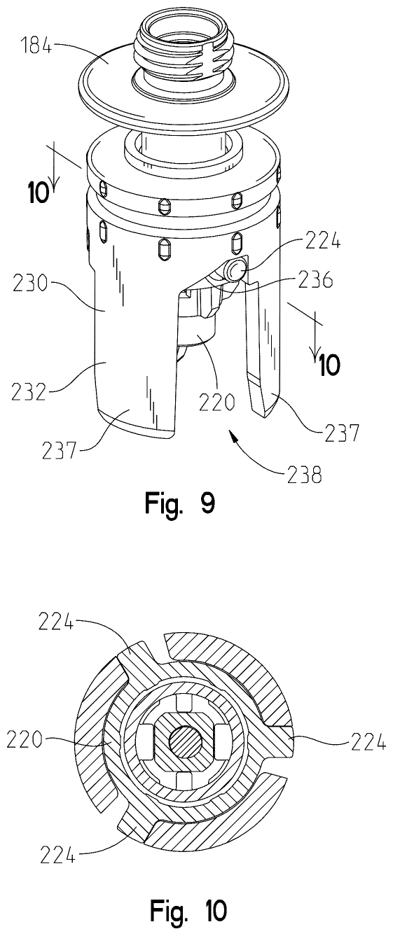

With reference to FIGS. 4 and 9, the illustrative fluid discharge control 140 further includes a cover or retainer 230 operably coupled to the rotatable drive 220. The cover 230 includes a body 232 received within the mounting shank 50. An o-ring 234 is supported by the body 232 and seals with the inner surface 156 of the mounting shank 50. The cover 230 further includes a ramp surface 236 configured to engage the pins 224 of the rotatable drive 220. The body of the cover 230 includes a plurality of axially extending legs 237 defining a plurality of circumferentially spaced slots 238 receiving the pins 224 of the rotatable drive 220. As further detailed herein, biasing of the trigger 144 toward the raised position causes the trigger 144 to rotate toward a rest or first rotational position.

Illustratively, the trigger 144 is operably coupled to the central body 184. The trigger 144 illustratively includes a frame 240 having a plurality of radially outwardly extending arms 242 extending radially outwardly from a central hub 244. A plurality of resilient inserts 246 are supported by upper channels 248 of the arms 242. The inserts 246 are illustratively formed of a polymer, such as an elastomer or silicone.

The trigger 144 is supported for axial movement along the longitudinal axis 52 between a raised position and a lowered position. A spring 250 biases the trigger 144 toward the raised position. The trigger 144 is also supported for rotational movement about the longitudinal axis 52 between a first rotational position (FIGS. 6A-6C) and a second rotational position (FIGS. 7A-7C). According to illustrative embodiments, the second rotational position of the trigger 144 is angularly offset from the first rotational position by between 15 degrees and 45 degrees. Illustratively, the angular offset is approximately 30 degrees.

The trigger 144 is biased toward the raised position and the first rotational position (FIGS. 6A-6C). The spring 250 biases the rotatable drive 220 upwardly toward the raised position, wherein engagement of the pins 224 with the ramp surfaces 236 cause rotation of the rotatable drive 220 toward the first rotational position. Moving the trigger 144 to the lowered position is configured to move the valve seal 174 away from the valve seat 160, thereby causing the valve 142 to be in the open position (FIGS. 7A-7C). In the closed position, the seal 174 of the valve stem 164 engages the valve seat 160 of the diverter body 152, thereby preventing water flow from the first fluid passageway 166 of the mounting shank 50 to the second fluid passageway 188 of the central body 184. In the open position, the seal 174 is spaced apart from the valve seat 160 such that the first fluid passageway 166 of the mounting shank 50 is in fluid communication with the second fluid passageway 188 of the central body 184, and thereby the outlets 148 of the sprayface 210.

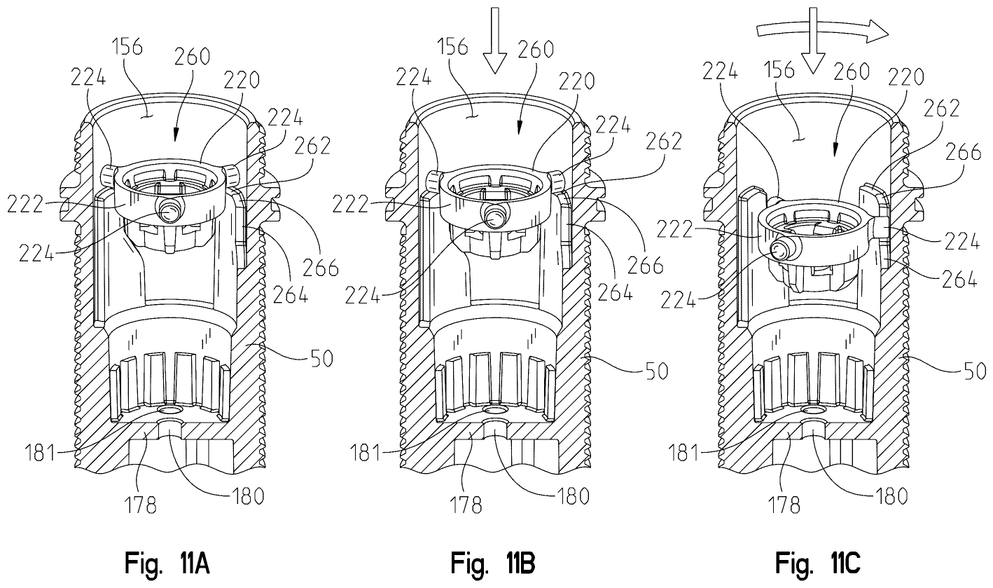

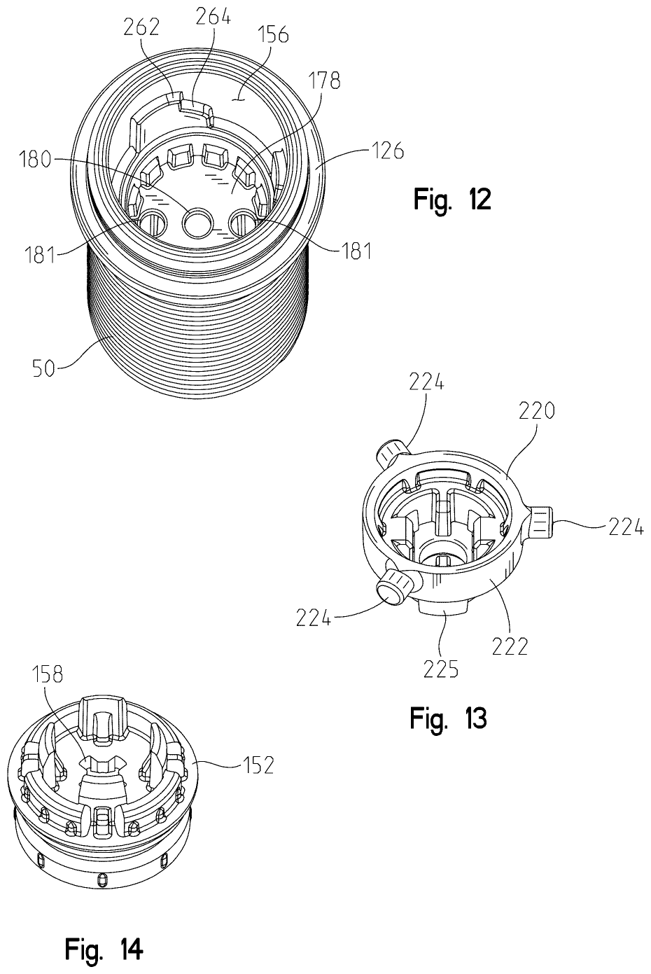

With reference to FIGS. 11A-12, a lock 260 is configured to prevent axial movement of the trigger 144 to the lowered position when the trigger 144 is in a first rotational position. The lock 260 includes a circumferential locking surface 262 and an axial slot 264 defined by the inner surface 156 of the mounting shank 50. A ramp surface 266 connects the locking surface 262 with the axial slot 264. The pins 224 of the rotatable drive 220 are configured to engage the circumferential locking surface 262 when the trigger 144 is in the first rotational position, and received within the axial slot 264 when the trigger 144 is in the second rotational position.

With reference to FIGS. 6A-7C and 11A-11C, operation of the illustrative vessel rinsing apparatus 10 is further detailed. FIG. 6A shows the glass 146 positioned above the trigger 144 of the vessel rinsing assembly 10. The trigger 144 is in the raised position and the first rotational position. As such, the valve 142 is in the closed position such that no water flows through the outlets 148 of the sprayface 210.

FIG. 7A shows the glass 146 depressing the trigger 144 of the vessel rinsing assembly 10. More particularly, a user initially rotates the trigger 144 is rotated clockwise by approximately 30 degrees to the second rotational position thereby axially unlocking the trigger 144 (as represented by arrow 270). The trigger 144 is then depressed by the user pressing down on the glass 146 to the lowered position (as represented by arrow 272). As such, the valve 142 is in the open position such that water flows through the outlets 148 of the sprayface 210.

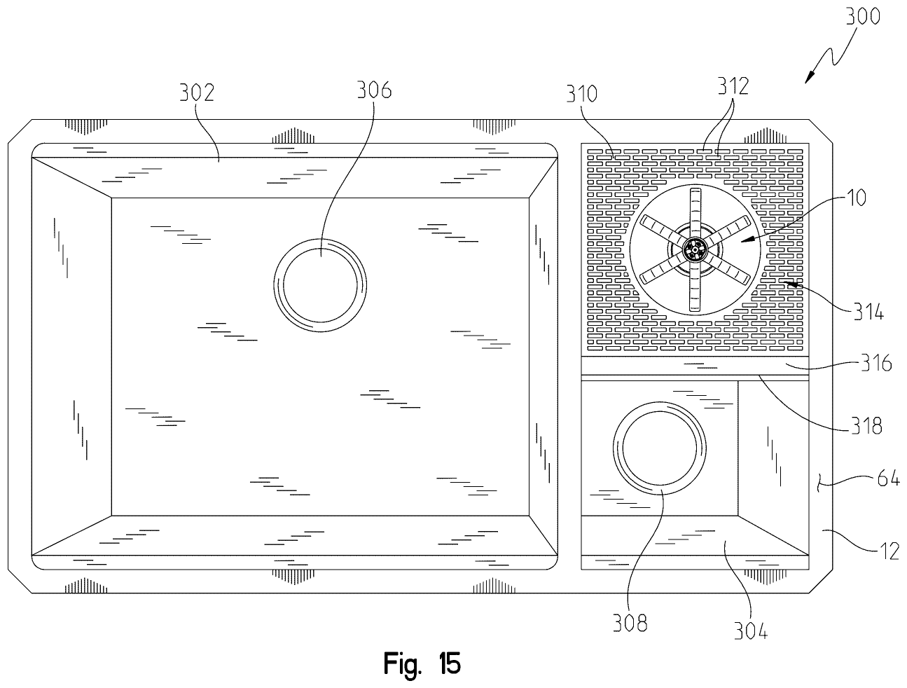

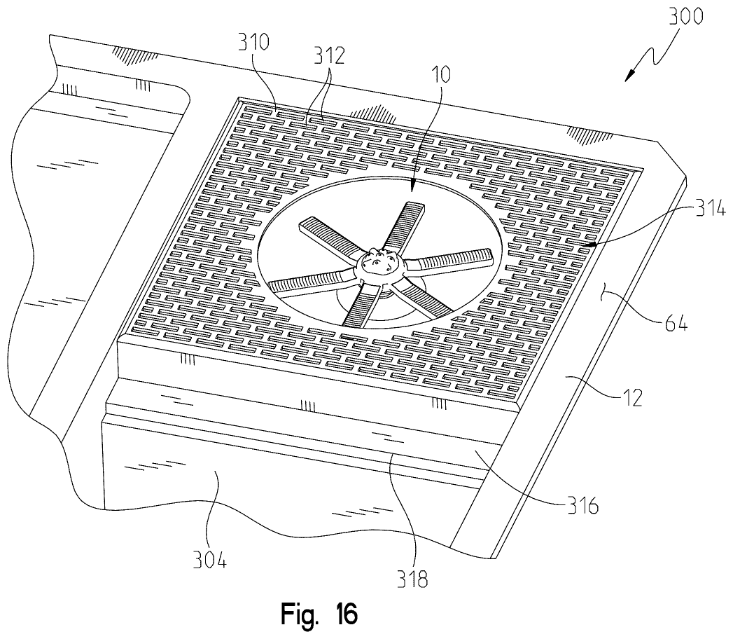

While FIG. 1 shows the vessel rinsing apparatus 10 supported above the upper surface 64 of the sink deck 12, it should be appreciated that other mounting arrangements may be substituted therefor. In the illustrative embodiment of FIGS. 15 and 16, the vessel rinsing apparatus 10 may be integrated into the sink deck 12 and recessed below the upper surface 64 thereof.

The sink 300 illustratively includes a first or main sink basin 302 and a second or auxiliary sink basin 304. The basins 302 and 304 extend downwardly from the upper surface 64 of the sink deck 12 and include drain openings 306 and 308, respectively. A cover 310, illustratively a grate, extends around the vessel rinsing apparatus 10 and includes a plurality of openings 312 to allow for the passage of water therethrough into a lower receptacle or bowl 314.

The lower receptacle 314 illustratively extends above the second sink basin 304 and includes a drain channel 316 having a ledge 318. Water from the lower receptacle 314 passes through the drain channel 316 over the ledge 318 and into the second sink basin 304. The water then passes to the drain opening 308.

Although the invention has been described in detail with reference to certain preferred embodiments, variations and modifications exist within the spirit and scope of the invention as described and defined in the following claims.

1. A vessel rinsing apparatus comprising:
a hollow, cylindrical mounting shank extending along a longitudinal axis, the mounting shank defining a first fluid passageway;
a valve including:
a valve seat supported by the mounting shank,
a valve stem movable along the longitudinal axis,
a valve seal supported by the valve stem,
wherein the valve stem is movable between a closed position and an open position, the valve seal being biased against the valve seat in the closed position;
a fluid discharge control including:
a central body extending along the longitudinal axis and at least partially disposed within the mounting shank, wherein the central body includes a second fluid passageway,
a sprayface supported by a first end of the central body and including at least one outlet in fluid communication with the second fluid passageway,
a trigger operably coupled to the central body,
wherein the trigger is movable for axial movement along the longitudinal axis between a raised position and a lowered position,
wherein the trigger is movable for rotational movement about the longitudinal axis between a first rotational position and a second rotational position,
wherein the trigger is biased toward the raised position,
wherein moving the trigger to the lowered position is configured to move the valve seal away from the valve seat causing the valve to be in the open position,
a lock configured to prevent movement of the trigger to the lowered position when the trigger is in the first rotational position; and
a drain bowl operably coupled to the mounting shank, the drain bowl defined by a base and an upwardly extending wall.

2. The vessel rinsing apparatus of claim 1, further comprising:
a drain channel fluidly coupled to the drain bowl; and
wherein in an installed condition of the rinsing apparatus, the drain bowl is positioned above the mounting deck, at least a portion of the drain channel is positioned above the sink basin, and the drain channel is configured to receive fluid from the drain bowl and discharge the fluid above and into the sink basin.

3. The vessel rinsing apparatus of claim 1, wherein the second rotational position of the trigger is angularly offset from the first rotational position by between 15 degrees and 45 degrees.

4. The vessel rinsing apparatus of claim 3, wherein the second rotational position of the trigger is angularly offset from the first rotational position clockwise by approximately 30 degrees.

5. The vessel rinsing apparatus of claim 1, wherein:
the fluid discharge control further includes:
a rotatable drive operably coupled to the central body; and
an engagement surface supported by the rotatable drive and configured to move the valve stem toward the open position when the trigger is in the lowered position; and
the valve further includes a fixed valve member supported within the mounting shank and defining the valve seat.

6. The vessel rinsing apparatus of claim 5, wherein:
the lock includes:
a circumferential locking surface, and
an axial slot defined by the mounting shank; and
the rotatable drive includes:
a body, and
a radially extending pin configured to engage the locking surface when the trigger is in the first rotational position, and received within the axial slot when the trigger is in the second rotational position.

7. The vessel rinsing apparatus of claim 6, wherein the trigger is biased toward the first rotational position.

8. The vessel rinsing apparatus of claim 7, wherein the fluid discharge control further includes a cover operably coupled to the rotatable drive, the cover including a ramp surface configured to engage the pin of the rotatable drive wherein biasing of the trigger toward the raised position causes the trigger to move toward the first rotational position.

9. The vessel rinsing apparatus of claim 1, wherein the trigger of the fluid discharge control includes a plurality of arms extending radially outwardly from the central body.

10. The vessel rinsing apparatus of claim 1, wherein a first spring biases the trigger toward the raised position.

11. The vessel rinsing apparatus of claim 10, wherein a second spring biases the valve seal against the valve seat.

12. The vessel rinsing apparatus of claim 1, further comprising a quick connect coupler operably coupled to a lower end of the mounting shank.

13. A drinkware rinsing apparatus comprising:
a drain bowl defined by a base and an upwardly extending wall;
a valve including:
a valve seat supported by the mounting shank,
a valve stem movable along the longitudinal axis,
a valve seal supported by the valve stem,
wherein the valve stem is movable between a closed position and an open position, the valve seal being biased against the valve seat in the closed position; and
a fluid discharge control including:
a central body extending along the longitudinal axis and at least partially disposed within the mounting shank, wherein the central body includes an outlet fluid passageway,
a sprayface supported by a first end of the central body and including at least one outlet in fluid communication with the fluid passageway, the sprayface located substantially within the drain bowl,
a trigger operably coupled to the central body,
wherein the trigger is movable for axial movement along the longitudinal axis between a raised position and a lowered position,
wherein the trigger is biased toward the raised position,
wherein the trigger is movable for rotational movement about the longitudinal axis between a first rotational position and a second rotational position,
wherein the trigger is biased toward the first rotational position,
wherein moving the trigger to the lowered position is configured to move the valve seal away from the valve seat causing the valve to be in the open position,
a lock configured to prevent movement of the trigger to the lowered position when the trigger is in the first rotational position.

14. The drinkware rinsing apparatus of claim 13, further comprising a hollow, cylindrical mounting shank extending along a longitudinal axis and operably coupled to the drain bowl, the mounting shank defining an inlet fluid passageway.

15. The drinkware rinsing apparatus of claim 14, further comprising:
a drain channel fluidly coupled to the drain bowl; and
wherein in an installed condition of the rinsing apparatus, the drain bowl is positioned above the mounting deck, at least a portion of the drain channel is positioned above the sink basin, and the drain channel is configured to receive fluid from the drain bowl and discharge the fluid above and into the sink basin.

16. The drinkware rinsing apparatus of claim 13, wherein the second rotational position of the trigger is angularly offset from the first rotational position by between 15 degrees and 45 degrees.

17. The drinkware rinsing apparatus of claim 16, wherein the second rotational position of the trigger is angularly offset from the first rotational position clockwise by approximately 30 degrees.

18. The drinkware rinsing apparatus of claim 13, wherein:
the fluid discharge control further includes:
a rotatable drive operably coupled to the central body; and
an engagement surface supported by the rotatable drive and configured to move the valve stem toward the open position when the trigger is in the lowered position; and
the valve further includes a fixed valve member supported within the mounting shank and defining the valve seat.

19. The drinkware rinsing apparatus of claim 18, wherein:
the lock includes:
a circumferential locking surface, and
an axial slot defined by the mounting shank; and
the rotatable drive includes:
a body, and
a radially extending pin configured to engage the locking surface when the trigger is in the first rotational position, and received within the axial slot when the trigger is in the second rotational position.

20. The drinkware rinsing apparatus of claim 19, wherein the fluid discharge control further includes a cover operably coupled to the rotatable drive, the cover including a ramp surface configured to engage the pin of the rotatable drive wherein biasing of the trigger toward the raised position causes the trigger to move toward the first rotational position.

21. The drinkware rinsing apparatus of claim 13, wherein the trigger of the fluid discharge control includes a plurality of arms extending radially outwardly from the central body.

22. The drinkware rinsing apparatus of claim 13, wherein a first spring biases the trigger toward the raised position.

23. The drinkware rinsing apparatus of claim 22, wherein a second spring biases the valve seal against the valve seat.

24. A vessel rinsing apparatus comprising:
a hollow, cylindrical mounting shank extending along a longitudinal axis, the mounting shank defining a first fluid passageway;
a valve including:
a fixed valve member supported within the mounting shank and defining a valve seat,
a valve stem movable along the longitudinal axis,
a valve seal supported by the valve stem,
wherein the valve stem is movable between a closed position and an open position, the valve seal being biased against the valve seat in the closed position;
a fluid discharge control including:
a central body extending along the longitudinal axis and at least partially disposed within the mounting shank, wherein the central body includes a second fluid passageway,
a sprayface supported by a first end of the central body and including at least one outlet in fluid communication with the second fluid passageway,
a trigger operably coupled to the central body,
wherein the trigger is movable for axial movement along the longitudinal axis between a raised position and a lowered position,
wherein the trigger is movable for rotational movement about the longitudinal axis between a first rotational position and a second rotational position,
wherein the trigger is biased toward the raised position,
wherein moving the trigger to the lowered position is configured to move the valve seal away from the valve seat causing the valve to be in the open position,
a lock configured to prevent movement of the trigger to the lowered position
when the trigger is in the first rotational position;
a rotatable drive operably coupled to the central body,
an engagement surface supported by the rotatable drive and configured to move the valve stem toward the open position when the trigger is in the lowered position;
a drain bowl operably coupled to the mounting shank, the drain bowl defined by a base and an upwardly extending wall;
a drain channel fluidly coupled to the drain bowl; and
wherein in an installed condition of the rinsing apparatus, the drain bowl is positioned above the mounting deck, at least a portion of the drain channel is positioned above the sink basin, and the drain channel is configured to receive fluid from the drain bowl and discharge the fluid above and into the sink basin.

25. The vessel rinsing apparatus of claim 24, wherein the second rotational position of the trigger is angularly offset from the first rotational position by between 15 degrees and 45 degrees.

26. The vessel rinsing apparatus of claim 25, wherein the second rotational position of the trigger is angularly offset from the first rotational position clockwise by approximately 30 degrees.

27. The vessel rinsing apparatus of claim 24, wherein:
the lock includes:
a circumferential locking surface, and
an axial slot defined by the mounting shank; and
the rotatable drive includes:
a body, and
a radially extending pin configured to engage the locking surface when the trigger is in the first rotational position, and received within the axial slot when the trigger is in the second rotational position.

28. The vessel rinsing apparatus of claim 27, wherein the trigger is biased toward the first rotational position.

29. The vessel rinsing apparatus of claim 28, wherein the fluid discharge control further includes a cover operably coupled to the rotatable drive, the cover including a ramp surface configured to engage the pin of the rotatable drive wherein biasing of the trigger toward the raised position causes the trigger to move toward the first rotational position.

30. The vessel rinsing apparatus of claim 24, wherein the trigger of the fluid discharge control includes a plurality of arms extending radially outwardly from the central body.

31. The vessel rinsing apparatus of claim 24, wherein a first spring biases the trigger toward the raised position.

32. The vessel rinsing apparatus of claim 31, wherein a second spring biases the valve seal against the valve seat.

33. The vessel rinsing apparatus of claim 24, further comprising a quick connect coupler operably coupled to a lower end of the mounting shank.
